(19) United States
(12) Patent Application Publication
(10) Pub. No.: US 2026/0041281 A1
(43) Pub. Date: Feb. 12, 2026

(54) COFFEE GRINDER WITH A CORRECTION SYSTEM OF THE DISPENSED COFFEE WEIGHT

(71) Applicant: CONTI VALERIO – S.R.L., Sesto Fiorentino (FI) (IT)

(72) Inventor: Maurizio FIORANI, Milano (IT)

(21) Appl. No.: 19/071,156

(22) Filed: Mar. 5, 2025

(30) Foreign Application Priority Data
Aug. 6, 2024 (IT) 102024000018433

(51) Int. Cl. A47J 42/44; A47J 42/40

(52) U.S. Cl. CPC A47J 42/44; A47J 42/40

(57) ABSTRACT

A coffee grinder has a coffee weight correction system that provides for comparing an error given by a difference between a measured weight measured by a load cell and a set weight set by a user with four threshold weights. If for two consecutive weighing operations the error is higher than the second weight threshold or lower than the first weight threshold, a correction algorithm makes a correction by setting a correction factor proportional to the modulus of the error of the last weighing operation.

### CROSS-REFERENCE TO RELATED APPLICATIONS

Not applicable.

### FIELD OF THE INVENTION

The present invention relates to a coffee grinder with a correction system of the dispensed coffee weight.

### BACKGROUND OF THE INVENTION

Coffee grinders provided with a support to support a filter holder suitable for being filled with a dose of ground coffee are known on the market. Such coffee grinders are equipped with a load cell connected to the support in order to weigh the ground coffee dispensed into the filter holder and stop the dispensing operation when the coffee weight reaches a preset dose.

EP3023041A1 describes such a type of coffee grinder with a load cell. When the grinder unit of the coffee grinder is stopped, the grinder unit continues to rotate due to inertia and thus a small amount of ground coffee continues to be dispensed from the dispensing duct. For such a reason, the grinder unit must be stopped in advance to prevent the weight of the dispensed coffee from exceeding the desired coffee weight. Such anticipation is known as “time-of-flight”.

To comply with the time-of-flight, the load cell can be set to a slightly lower weight than the desired weight of the coffee dose. Otherwise said, a time-of-flight weight equal to the weight of coffee dispensed during the time-of-flight is subtracted from the desired dose weight. Therefore, the grinder unit stops when the weight detected by the load cell is equal to the desired weight minus the time-of-flight weight.

However, the time-of-flight is not constant for all types of coffee, and depends on the specific grain size of the ground coffee. The finer the grain size, the higher the time-of-flight to be considered. In addition, the time-of-flight also depends on the mechanical structure of the grinders and on the electronics that operates the grinders. Therefore, the coffee grinders of the prior art are generally impaired by errors and inaccuracies in the dosing system that are mainly due to an incorrect calculation of the time-of-flight and of the relative time-of-flight weight.

WO2020089706A1 describes a system for correcting the time-of-flight weight (called “value Δ”) that takes into account an average of the weights of multiple weighing operations. However, the average of the weighing operations does not give a reliable correction value. In fact, generally speaking, the dispensing of the coffee powder during the grinding operation is quite regular, but extraordinary situations may occur during the final deceleration step of the grinders in which the coffee powder remains in the grinding chamber and creates a coffee lump. Or there might be a coffee lump in the grinding chamber when the motor of the grinders has already stopped. In such a case, because of the coffee lump, the coffee dose falling during the time-of-flight is inaccurate and creates an error in the amount of the dispensed coffee. Therefore, such an average is not reliable if the weight average includes the weighing of a dispensing operation in which there was a lump.

EP4331450A1 describes a coffee grinder in which the time-of-flight weight (called “tare weight”) is increased by excess, so that the weight of the dispensed coffee dose is always lower than the weight of the desired coffee dose. Then, extra coffee doses (refills) are dispensed, so that the weight of the dispensed coffee dose is as close as possible to the weight of the desired coffee dose. In such a case, evidently, no correction of the time-of-flight weight is necessary since the approximation to the desired dose is achieved with refills.

### SUMMARY OF THE INVENTION

The purpose of the present invention is to eliminate the drawbacks of the prior art by providing a coffee grinder with a correction system of the dispensed coffee weight that is accurate and reliable.

Another purpose is to provide such a grinder that can automatically control the dispensing of a ground coffee dose, regardless of the grain size of the coffee and of the mechanics and electronics of the grinder.

Still another purpose of the present invention is to provide such a coffee grinder that is easy to make and easy to use.

These purposes are achieved in accordance with the invention with the features of the attached independent claims.

Advantageous embodiments of the invention appear from the dependent claims.

The coffee grinder according to the invention is defined by claim 1.

Whereas the prior art provides for using a correction factor given by the average of multiple weighing operations which may include weighing operations that are out of measure in order to correct the time-of-flight weight, the coffee grinder according to the invention does not take into account any dispensing operation that is out of measure, and only intervenes when the error is repeated for two consecutive times.

In such a case the time-of-flight weight is corrected in case of an error confirmation for two consecutive times. In any case, only a small part of the error (¼ E) is corrected if the error is small and the error is totally corrected if the error is large. This is done to minimize the chances of introducing errors on inaccurate weighing operations due to problems that are not caused by an actual variation of the time-of-flight.

### BRIEF DESCRIPTION OF DRAWINGS

Further features of the invention will appear clearer from the following detailed description, which refers to a purely illustrative and therefore non-limiting embodiment illustrated in the appended drawings.

FIG. 1 is a schematic side view of a coffee grinder according to the invention.

FIG. 2 is a block diagram of the coffee grinder of FIG. 1.

FIG. 3 is a diagram illustrating four threshold weights and the various operations of the coffee grinder in the five ranges defined by the four threshold weights.

FIG. 4 is a flowchart illustrating a first operating step of the coffee grinder of FIG. 1 during a continuous weight detection.

FIG. 5 is a flow diagram illustrating the operation of the coffee grinder of FIG. 1 after one and after multiple dispensing operations of coffee doses.

### DETAILED DESCRIPTION OF THE INVENTION

With the aid of the Figures, the coffee grinder according to the invention is described, which is comprehensively indicated by the reference numeral 100.

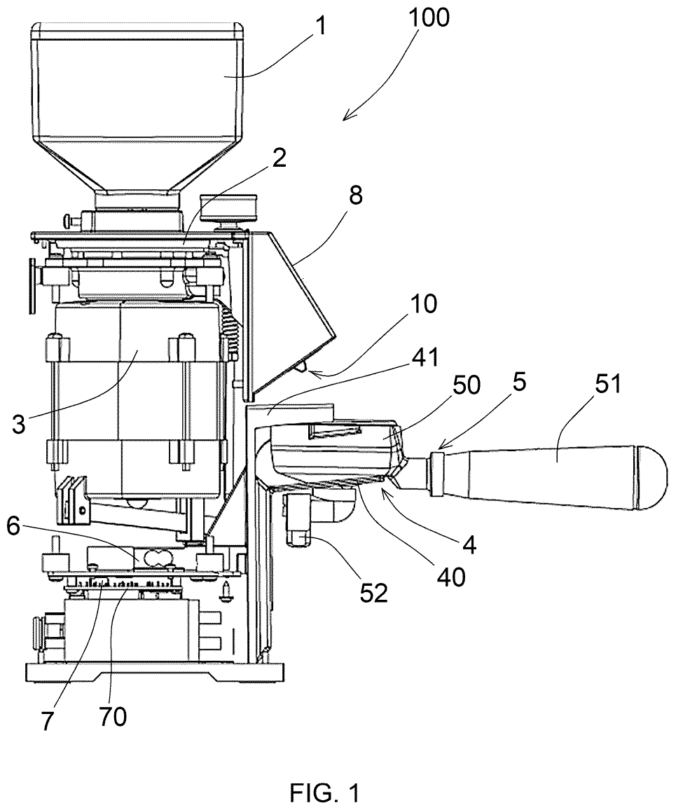

With reference to FIG. 1, the coffee grinder (100) comprises:
a hopper (1) for loading coffee beans,
a grinder unit (2) to grind the coffee beans into coffee powder,
an electric motor (3) to move the grinder unit (2),
a dispensing unit (10) to dispense powder coffee,
a support (4) to support a filter holder (5) under the dispensing unit (10),
a load cell (6) connected to the support (4) to weigh the coffee powder in the filter holder (5),
a control unit (7) electrically connected to the load cell (6), and
a user interface (8) connected to the control unit (7).

The filter holder (5) is a typical filter holder for a coffee machine. The filter holder (5) comprises:
a substantially cylindrical container (50),
a handle (51) protruding radially from the container, and
a dispensing nozzle (52) that protrudes inferiorly from the container to dispense liquid coffee.

The support (4) comprises:
a fork (40) suitable for supporting the container (50) of the filter holder, and
a bracket (41) that connects the fork (40) to the load cell (6).

The load cell (6) is connected to a printed circuit board (PCB) (70) on which the control unit (7) is mounted.

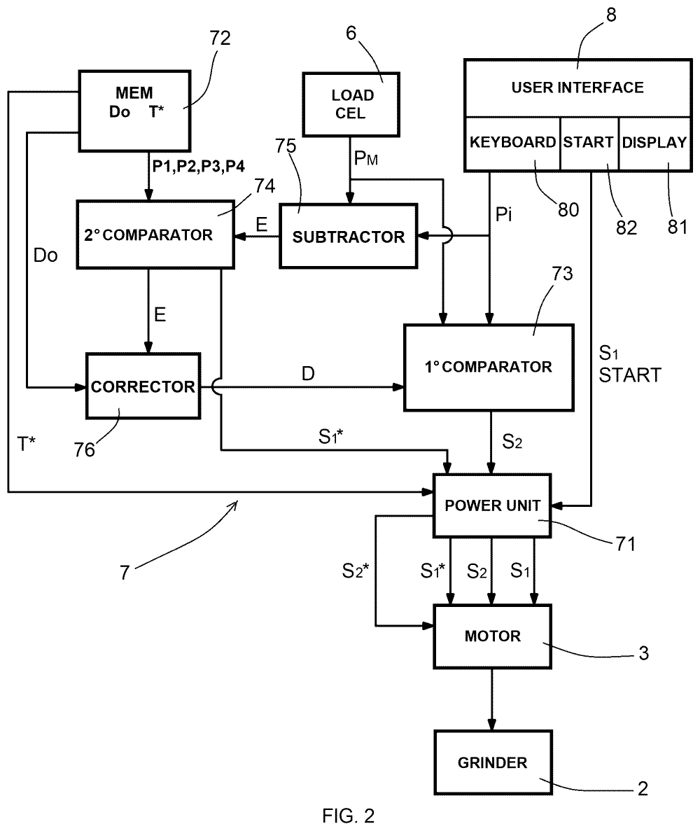

With reference to FIG. 2, the control unit (7) comprises:
a power unit (71) to drive the electric motor (3),
a memory (72) in which some operating parameters of the coffee grinder are stored, and
a first comparator (73) and a second comparator (74) to perform comparisons between parameters and variables.

The user interface (8) comprises:
a keyboard (80) used by the user to enter a set weight (Pi) of a coffee dose,
a display (81) to display the set weight entered by the user, and
a start button (82) to send a start signal (S1) to start the grinding cycle.

The load cell (6) continuously detects a measured weight (Pm) of the coffee powder falling into the filter holder. Obviously, the load cell (6) is set to subtract the weight of the filter holder (5) and obtain the net weight of the coffee in the filter holder.

The first comparator (73) receives the set weight (Pi), the measured weight (Pm) and a time-of-flight weight (D). The first comparator (73) is configured to compare the measured weight (Pm) with the set weight (Pi) minus the time-of-flight weight (D). Otherwise said, the first comparator (73) performs the following comparison:

$$Pm = Pi - D$$

When the measured weight (Pm) is equal to the set weight (Pi) minus the time-of-flight weight (D), the first comparator (73) sends a stop signal (S2) to the power unit (71) to stop the motor (3) of the grinder unit.

The control unit (7) is configured to implement a correction algorithm (76) to correct the time-of-flight weight (D). The correction algorithm (76) calculates a correction factor (C) to be added to the time-of-flight weight calculated in the previous weighing operation, as described in detail hereinafter.

The following parameters are stored in the memory (72):
an initial time-of-flight weight (Do) that is calculated empirically and takes into account the time-of-flight of the grinder unit,
a first weight threshold (P1), a second weight threshold (P2), a third weight threshold (P3), and a fourth weight threshold (P4) that define error ranges, in which the coffee grinder does not correct the time-of-flight weight, corrects the weight time-flight, or performs a refill, and
an extra-dose time (T*) that takes into account a time for the grinder unit (2) to let the grinders make an extra travel to dispense an extra dose (refill) of ground coffee.

The time-of-flight is the time in which the grinder unit (2) continues to rotate due to inertia after the motor (3) is turned off.

Therefore, the initial time-of-flight weight (Do) is set by the machine manufacturer based on experimental tests done with coffee grinders in the case of grinding espresso beans. For illustrative purposes, the initial time-of-flight weight (Do) is set to a value of 1-1.2 g, preferably 1.1 g.

The first weight threshold (P1) has a negative value, for example a value in the range between 0.04 g and 0.06 g, preferably 0.05 g. Such a first weight threshold (P1) takes into account the possibility that a dose with a measured weight (Pm) that is lower than the set weight (Pi) is obtained at the completion of the dispensing operation.

The second weight threshold (P2) has a positive value, for example, a value in the range between 0.1 g and 0.2 g, preferably 0.15 g. Such a second weight threshold (P2) takes into account the possibility that a dose with a measured weight (Pm) that is higher than the set weight (Pi) is obtained at the completion of the dispensing operation.

The third weight threshold (P3) has a negative value that is lower than the first weight threshold (P1). For example, the third weight threshold (P3) has a value in the range between 0.08 g and 0.12 g, preferably 0.1 g. This third weight threshold (P3) takes into account the possibility that a dose with a measured weight (Pm) that is much lower than the set weight (Pi) is obtained at the completion of the dispensing operation, and therefore in this case one or more refills are necessary.

The fourth weight threshold (P4) has a negative value that is much lower than the third weight threshold (P3). For example, the fourth weight threshold (P4) has a value in the range between 1.2 g and 2 g, preferably 1.6 g. The fourth weight threshold (P4) takes into account that there was an obvious error in the weighing operation and therefore the motor of the machine must be restarted.

The extra-dose time (T*) is calculated to let the grinder unit (2) make an extra travel, dispensing a minimum amount of coffee powder (extra-dose). By way of example, the extra-dose time (T*) is calculated for 0.05-0.15 g of coffee powder to be dispensed.

An error (E) is defined in the operation of the grinder unit as the difference between the measured weight (Pm) and the set weight (Pi) at the completion of the dispensing operation, i.e. after the motor is stopped and some coffee has fallen due to time-of-flight; that is to say:

$$E = Pm - Pi$$

For such a purpose, the control unit (7) comprises a subtractor (75) that receives the set weight (Pi) and the measured weight (Pm) at the completion of the dispensing operation and calculates the error (E).

In the second comparator (74), the error (E) is compared with the four threshold weights (P1, P2, P3. P4) to define three different operating modes of the machine, namely a mode without correction, a mode with correction of the time-of-flight weight (D) and a mode with refills.

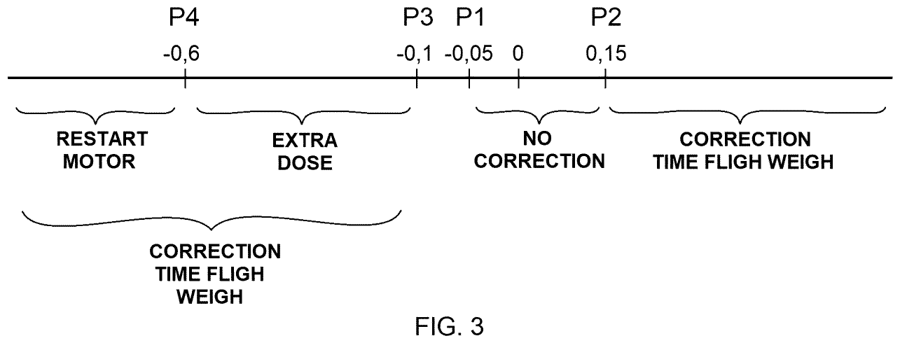

With reference to FIG. 3, no correction is made if the error (E) is comprised in a range between the first threshold weight (P1) and the second threshold weight (P2).

The time-of-flight weight (D) is corrected if the error (E) is higher than the second threshold weight (P2) for two consecutive weighing operations.

The time-of-flight weight (D) is corrected if the error (E) is lower than the first threshold weight (P1) for two consecutive weighing operations.

An extra-dose is dispensed for an extra-dose time (T*), if the error (E) is comprised between the fourth threshold weight (P4) and the third threshold weight (P3).

The motor is restarted if the error (E) is lower than the fourth threshold weight (P4) because there was an obvious weighing error.

Following is an explanation of how the time-of-flight weight (D) is corrected.

The time-of-flight weight (Dₙ) to be applied in an n-th weighing operation is given by the time-of-flight weight (Dₙ₋₁) of the previous weighing operation plus a correction factor (Cₙ₋₁) calculated based on the error (E(ₙ₋₁) of the previous weighing operation, that is to say:

$${D}_{n} = {D}_{n - 1} + {C}_{n - 1}$$

The control unit of the grinder has a counter that counts the number of consecutive weighing operations in which the error (E) is higher than the second threshold weight (P2) or the error (E) is lower than the first threshold weight (P1).

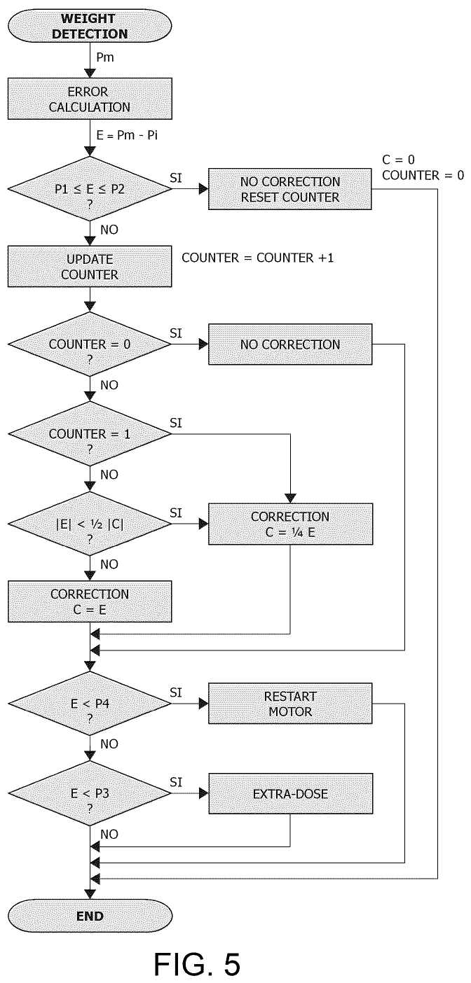

With reference to FIG. 5, if the error (E) is comprised in the range between the first threshold weight (P1) and the second threshold weight (P2), the correction factor (C) is zero, i.e., no correction is made and the counter is reset to zero.

Instead, if the error (E) is higher than the second threshold weight (P2) or the error (E) is lower than the first threshold weight (P1), the counter is updated and increased by 1.

No correction is made if the counter is equal to zero and further comparisons of the error (E) are performed.

If the counter is equal to 1, it means that, for the first time, two consecutive weighing operations had an error (E) that is higher than the second threshold weight (P2) or an error (E) that is lower than the first threshold weight (P1). In such a case, a correction factor (C) proportional to the modulus of the error (E) is calculated. The correction factor (C) is calculated as a fraction of the modulus of the error, specifically one quarter of the error; i.e.

$$C = 1 / 4 \vert E \vert$$

In such a case, the time-of-flight weight of the following weighing operation is corrected with the correction factor (C) that was previously calculated.

If the counter is higher than 1, it means that more than two consecutive weighing operations occurred in which the error (E) is higher than the second threshold weight (P2) or the error (E) is lower than the first threshold weight (P1). In such a case, the correction algorithm (76) performs a comparison of the modulus of the error (Eₙ) with the previous correction factor (Cₙ₋₁). If the modulus of the error (Eₙ) is lower than half of the previous correction factor, then the successive correction factor is always ¼ of the modulus of the error, otherwise the correction factor is increased in the same way as the modulus of the error, that is to say:

$$If \vert En \vert < 1 / 2 {C}_{n - 1} , then {C}_{n} = 1 / 4 \vert En \vert , otherwise {C}_{( n )} . = \vert En \vert$$

This is done in order to discriminate small weight variations due to environmental changes from large weight variations due to a change in the distance of the grinders.

In any case, the control unit of the coffee grinder performs additional comparisons.

If the error (E) is lower than the fourth threshold weight (P4), it means that there was an obvious error in the dispensing operation, so the motor of the grinder unit is restarted for another dispensing operation.

If the error (E) is comprised between the fourth threshold weight (P4) and the third threshold weight (P3), a refill procedure is initiated in which an extra-dose is dispensed. The motor of the grinder unit is operated for an extra-dose time (T*). The power unit (71) sends an extra-dose start signal (S1*) to the motor (3) of the grinders, and after the extra-dose time (T*), the power unit (71) sends an extra-dose end signal (S2*) to the motor (3) of the grinders.

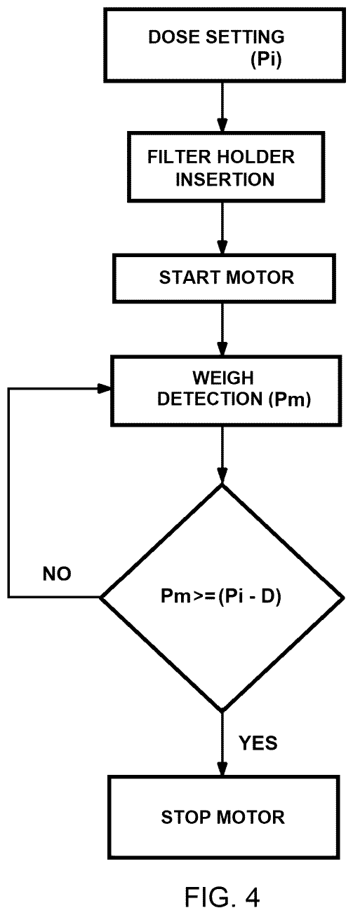

With reference to FIGS. 2 and 4, using the keyboard (80) of the user interface, the user enters the set weight (Pi) of the coffee powder dose to be obtained, reading the weight that is set on the display (81).

Then the user inserts the filter holder (5) into the support (4) and presses the start button (82) that emits a start signal (S1) to the power unit (71) that drives the motor (3) that moves the grinder unit (2). The grinder unit grinds the coffee beans into coffee powder that is dispensed from the dispensing unit (10) and falls into the container (50) of the filter holder.

When the coffee powder is dispensed from the dispensing unit (10) and falls into the filter holder (5), the load cell (6) continuously detects the measured weight (Pₘ) of the coffee powder in the filter holder.

The first comparator (73) is configured to compare the measured weight (Pₘ) detected by the load cell with the set weight (Pi) minus the time-of-flight weight (D).

When the measured weight (Pm) is higher than or equal to the set weight (Pi) minus the time-of-flight weight (D), then the first comparator (73) sends a stop signal (S2) to the power unit (71) that stops the motor (3) of the grinder unit (2). Therefore, the grinder unit (2) is stopped in advance, when the weight of the coffee in the filter holder has not reached yet the set weight (Pi). During the time-of-flight, the grinders continue to rotate by inertia and more coffee powder is dispensed, falling into the filter holder (5).

Regarding the first dispensing operation of a dose, the time-of-flight weight (D) is set to the initial time-of-flight weight (Do).

With reference to FIG. 5, after the first dispensing operation, a first weighing operation is performed, in which the first dose is weighed and the first error E₁ is calculated and compared with the threshold weights.

No correction is made and the counter is reset to zero if the first error (E₁) is comprised in the range between the first threshold weight (P1) and the second threshold weight (P2).

The counter is updated and counts a first event if the first error (E₁) is higher than the second threshold weight (P2) or lower than the first threshold weight (P1).

The motor of the grinder unit is restarted if the first error (E₁) is higher than the fourth threshold weight (P4).

If the first error (E₁) is comprised between the fourth threshold weight (P4) and the third threshold weight (P3), an extra dose is dispensed for the extra-dose time (T*).

The second dispensing operation is performed. After the second dispensing operation, a second weighing operation is performed in which the second dose is weighed and the second error E2 is calculated and compared with the threshold weights.

If the second error (E₂) is comprised in the range between the first threshold weight (P1) and the second threshold weight (P2), no correction is made and the counter is reset to zero.

If the second error (E₂) is higher than the second threshold weight (P2) or lower than the first threshold weight (P1), the counter is updated and counts two consecutive events. Therefore, in such a case a correction factor (C₂) proportional to the modulus of the second error is calculated, which is namely equal to ¼ of the modulus of the second error (E₂).

Such a correction factor (C₂) is used to correct the time-of-flight weight (D) to be applied for the third dispensing operation. Therefore, during the third dispensing operation, the weight time-flight will be:

$$D 3 = Do + {C}_{2}$$

If the second error (E₂) is higher than the fourth threshold weight (P4), the motor of the grinder unit is restarted.

If the second error (E₂) is comprised between the fourth threshold weight (P4) and the third threshold weight (P3), an extra dose is dispensed for the extra-dose time (T*).

The third dispensing operation is performed. After the third dispensing operation, a third weighing operation is performed, in which the third dose is weighed and the third error (E₃) is calculated and compared with the threshold weights.

If the third error (E₃) is comprised in the range between the first threshold weight (P1) and the second threshold weight (P2), no correction is made and the counter is reset to zero.

If the third error (E₃) is higher than the second threshold weight (P2) or lower than the first threshold weight (P1), the counter is updated and counts three consecutive events. Therefore, in such a case a correction factor (C₃) proportional to the third error is calculated.

If the modulus of the third error (E₍₃) is lower than ½ of the previous correction factor (C₂), the correction factor (C₃) will be ¼ of the modulus of the third error (E₃). Instead, if the modulus of the third error (E₍₃) is higher than ½ of the previous correction factor (C₂), the correction factor (C₃) will be equal to the modulus of the third error (E₃).

The correction factor (C₃) calculated at the completion of the third weighing operation will be used to correct the time-of-flight weight to be applied for the fourth weighing operation.

If the third error (E₃) is higher than the fourth threshold weight (P4), the motor of the grinder unit is restarted.

If the third error (E₃) is comprised between the fourth threshold weight (P4) and the third threshold weight (P3), an extra dose is dispensed for the extra-dose time (T*).

Now, reference is made to a weighing operation after the third weighing operation. If the weights of the two previous weighing operations (i.e., weighing n−2 and weighing n−1) are higher than the second threshold value (P2) or are comprised in the range between the third threshold value (P3) and the first threshold value (P1), a correction factor Cn−1 that is proportional to the previous weighing operation is calculated. If the modulus of the error (En−1) of the last weighing operation is lower than ½ of the correction factor (Cn−2) of the penultimate weighing operation, the correction factor (Cn−1) to be applied in the weighing operation n is ¼ of the modulus of the error (En−1) of the previous weighing operation.

If the modulus of the error (En−1) of the last weighing operation is higher than ½ of the correction factor (Cn−2) of the penultimate weighing operation, the correction factor (Cn−1) to be applied in the weighing operation n is equal to the modulus of the error (En−1) of the previous weighing operation.

Numerous variations and equivalent changes may be made to the present embodiment of the invention, within the scope of a technician of the field, falling in any case in the scope of the invention as expressed by the appended claims.

1. A coffee grinder comprising:
a hopper for loading coffee beans;
a grinder unit to grind the coffee beans into coffee powder;
an electric motor to operate the grinder unit;
a dispensing unit to dispense coffee powder;
a support to support a filter holder under the dispensing unit;
a load cell connected to the support to weigh the coffee powder inside the filter holder, in such a way to have a measured weight (Pₘ) of the coffee in the filter holder;
a control unit electrically connected to the load cell (6); and
a user interface connected to the control unit;
wherein said control unit comprises:
a power unit to drive the electric motor;
a memory wherein operating parameters of the coffee grinder are stored; and
a first comparator to make comparisons between parameters and variables;
wherein said user interface comprises:
a keyboard used by the user to enter a set weight (Pᵢ) of a coffee dose;
a display to display the set weight entered by the user;
a start button to start the grinding cycle;
wherein the following parameters are stored in said memory:
an initial time-of-flight weight (Do) that takes into account the time-of-flight of the grinder unit;
a first weight threshold (P1) of negative value, a second weight threshold (P2) of positive value, a third weight threshold (P3) of negative value that is lower than the first weight threshold (P1), and a fourth weight threshold (P4) of negative value that is lower than the third weight threshold (P3); and
an extra-dose time (T*) that takes into account an operating time of the grinder unit in such a way that the grinders make an extra travel to dispense an extra-dose of ground coffee;
said control unit being configured to correct a time-of-flight weight (D) that is initially set to the initial time-of-flight weight (Do);
said first comparator being configured in such a way that, after pushing the start button, the first comparator compares the measured weight (Pₘ) detected by the load cell with the set weight (Pᵢ) set by the user minus the time-of-flight weight (D), and when the measured weight (Pₘ) is equal to the set weight (Pᵢ) minus the time-of-flight weight (D), then the first comparator sends a stop signal (S2) to the power unit to stop the motor of the grinder unit;
said control unit comprising:
a correction algorithm suitable for detecting a correction factor (C) to correct said time-of-flight weight (D),
a subtractor to subtract the set weight (Pᵢ) from the measured weight (Pₘ) at the end of a dispensing operation so as to obtain an error (E),
a second comparator that compares said error (E) with said weight thresholds (P1, P2, P3, P4), so that:
if the error (E) is comprised in a range between the first weight threshold (P1) and the second weight threshold (P2), no correction is made to the time-of-flight weight (D) and no refill is performed,
if the error (E) is greater than the second weight threshold (P2) for two consecutive weighing operations, the correction algorithm (76) makes the correction, setting a correction factor (C) proportional to the modulus of the error (E) of the last weighing operation,
if the error (E) is lower than the first weight threshold (P1) for two consecutive weighing operations, the correction algorithm (76) corrects the time-of-flight weight (D) by setting a correction factor (C) proportional to the modulus of the error (E) of the last weighing operation.
if the error is lower than the fourth weight threshold (P4), the motor of the grinder unit is restarted,
if the error (E) is comprised between the fourth weight threshold (P4) and the third weight threshold (P3), a refill is performed by dispensing an extra-dose of ground coffee for said extra-dose time (T*),

2. The coffee grinder according to claim 1, wherein:
said first weight threshold (P1) has a negative value in the range from −0.04 g to −0.06 g;
said second weight threshold (P2) has a positive value in the range from 0.1 g to 0.2 g;
said third weight threshold (P3) has a negative value in the range from −0.08 g to −0.12 g; and
said fourth weight threshold (P4) has a negative value in the range from −1.2 g to −2 g.

3. The coffee grinder of claim 1, wherein said initial time-of-flight weight (Do) is comprised in the range from 1 to 1.2 g.

4. The coffee grinder of claim 1, wherein:
said correction factor (C) is ¼ of the modulus of the error (E) if the modulus of the error (E) is lower than ½ of the correction factor of the previous weighing operation; said correction factor (C) is equal to the modulus of the error (E) if the modulus of the error (E) is greater than 1/2 of the correction factor of the previous weighing operation.

5. The coffee grinder of claim 1, wherein said extra-dose time (T*) is calculated in such a way that the grinder unit makes an extra travel, dispensing an amount of coffee powder comprised between 0.05 and 0.15 g.

6. Method for dispensing a dose of coffee ground with a coffee grinder of claim 1, comprising the following steps:
(a) setting a set weight (Pᵢ) of a coffee dose;
(b) inserting the filter holder into the support of the coffee grinder;
(c) starting the motor of the grinder unit;
(d) detecting a measured weight (Pₘ) of the coffee powder in the filter holder;
(e) comparing the measured weight (Pₘ) with the set weight (Pᵢ) minus the time-of-flight weight (D);
(f) stopping the motor of the grinder unit when the measured weight (Pₘ) is equal to the set weight (Pᵢ) minus the time-of-flight weight (D);
(g) waiting for a waiting time since the stop of the motor;
(h) detecting the measured weight (Pm) of a coffee powder dose;
(i) calculating an error (E) as difference between the measured weight (Pₘ) of a dose and the set weight (Pᵢ),
(j) comparing said error (E) with said weight thresholds (P1, P2, P3, P3), so that:
(j1) if the error (E) is comprised in a range between the first weight threshold (P1) and the second weight threshold (P2), no correction is made to the time-of-flight weight (D) and no refill is performed;
(j2) if the error (E) is greater than the second weight threshold (P2) for two consecutive weighing operations, the correction algorithm makes the correction, setting a correction factor (C) proportional to the modulus of the error (E) of the last weighing operation;
(j3) if the error (E) is lower than the first weight threshold (P1) for two consecutive weighing operations, the correction algorithm (76) corrects the time-of-flight weight (D), setting a correction factor (C) proportional to the modulus of the error (E) of the last weighing operation;
(j4) if the error is lower than the fourth weight threshold (P4), the motor of the grinder unit is restarted; and
(j5) if the error (E) is comprised between the fourth weight threshold (P4) and the third weight threshold (P3), a refill is performed, dispensing an extra-dose of ground coffee for said extra-dose time (T*).

7. The method of claim 6, wherein:
said first weight threshold (P1) has a negative value in the range from −0.04 g to −0.06 g;
said second weight threshold (P2) has a positive value in the range from 0.1 g to 0.2 g;
said third weight threshold (P3) has a negative value in the range from −0.08 g to −0.12 g; and
said fourth weight threshold (P4) has a negative value in the range from −1.2 g to −2 g.

8. The method of claim 6, wherein said initial time-of-flight weight (Do) is comprised in the range from 1 to 1.2 g.

9. The method of claim 6, wherein
said correction factor (C) is ¼ of the modulus of the error (E) if the modulus of the error (E) is lower than ½ of the correction factor of the previous weighing operation;
said correction factor (C) is equal to the modulus of the error (E) if the modulus of the error (E) is greater than ½ of the correction factor of the previous weighing operation.

10. The method of claim 6, wherein said extra-dose time (T*) is calculated in such a way that the grinder unit makes an extra travel to dispense an amount of coffee powder comprised between 0.05 and 0.15 g.
